(19) United States
(12) Patent Application Publication
(10) Pub. No.: US 2017/0167443 A1
(43) Pub. Date: Jun. 15, 2017

(54) VEHICLE NATURAL GAS FUEL SUPPLY SYSTEMS

(71) Applicant: Calum McClure, Richmond (CA)

(72) Inventor: Calum McClure, Richmond (CA)

(21) Appl. No.: 14/963,377

(22) Filed: Dec. 9, 2015

(51) Int. Cl. F02M 21/02; F02B 43/10; F02D 19/02

(52) U.S. Cl. CPC F02M 21/0215; F02M 21/0221; F02M 21/0242; F02M 21/0227; F02D 19/022; F02D 19/027; F02B 43/10; F02M 21/0239; F02M 21/0287; F02B 2043/103

(57) ABSTRACT

A vehicle natural gas fuel supply system includes a vehicle-tank natural gas fuel supply assembly and a vehicle natural gas fuel supply assembly, and at least one quick-connect-coupler for removably coupling the vehicle-tank natural gas fuel supply assembly and the vehicle natural gas fuel supply assembly. The vehicle-tank includes a natural gas tanker-trailer and the vehicle-tank is a pressurized vessel. A vehicle natural gas fuel supply system may eliminate a need to vent captured natural gas from the vehicle-tank. The captured natural gas, by remaining in a closed system and not being vented, effectively prevents unburned methane from entering into an ambient environment. The captured natural gas is directed through an air-gas mixer before reaching the engine of the prime-mover for motive action.

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

1. Field of the Invention

The present invention relates generally to the field of vehicle fuel systems and more specifically relates to a vehicle natural gas fuel supply system.

2. Description of Related Art

Most vehicles used today are powered by an internal combustion engine. In the case of tractor-trailers, many are either powered by diesel, gasoline, propane, natural gas or a combination thereof. Based on fuel prices, environmental benefits, and availability, natural gas has become a more desirable fuel source and demand is likely to grow in the future. In some cases, natural gas is transported by tractor-trailer in a liquid form to be delivered to customers. This liquid form of natural gas can pose some limitations caused by the fact that liquid natural has gas a low boiling point and becomes a gas at normal atmospheric temperature and pressure. In order to safely transport the natural gas in a liquid form, the tanker trailer must have the capability to vent excess pressure and gas to the atmosphere, causing harmful methane emissions and wasted fuel. In other cases, natural gas may also be transported in the form of a compressed gas.

The tractor itself may be powered by a natural gas fuel source. Currently, if natural gas it to be used for fueling the tractor's engine, it must either have on-board liquefied natural gas storage or compressed natural gas storage tanks to ensure that the fuel is stored and provided to the engine at the correct temperature, pressure and flow rate. However, the range of on-board natural gas fuel tanks is limited by the tank capacity and requires purpose-built refueling infrastructure to refill the onboard fuel tanks. Therefore, a suitable solution is desired.

Several attempts have been made to solve the above-mentioned problems such as those found in Foreign and U.S. Pat. and Pub. Nos. CA 2,127,777 to Gustafson, et al., U.S. Pat. No. 5,231,838 to Cieslukowski, U.S. Pat. No. 6,698,211 to Gustafson, EP 2,617,587 to Lee et al., U.S. Pat. No. 5,409,046 to Swenson et al., U.S. Pat. No. 5,127,230 to Neeser, et al., U.S. Pat. No. 7,044,113 to Bingham et al., US 2013/0061608 to Lurken et al., U.S. Pat. No. 5,325,894 to Kooy et al., and U.S. Pat. No. 5,699,839 to Dehne. This art is representative of vehicle fuel systems. However, none of the above inventions and patents, taken either singly or in combination, is seen to describe the invention as claimed.

Preferably, a vehicle natural gas fuel supply system should provide a system for a tractor to be fueled directly from tanker trailer pulled by the tractor (or natural gas tanks mounted to a tractor as cargo) with the ability to take the natural gas vapor directly from the vapor space of a liquefied natural gas tanker or from the compressed natural gas cylinders from a compressed natural gas trailer, yet would operate reliably and be manufactured at a modest expense. Thus, a need exists for a reliable vehicle natural gas fuel supply system to avoid the above-mentioned problems.

### BRIEF SUMMARY OF THE INVENTION

In view of the foregoing disadvantages inherent in the known vehicle fuel systems art, the present invention provides a novel vehicle natural gas fuel supply system. The general purpose of the present invention, which will be described subsequently in greater detail is to provide a means to fuel a tractor directly from a liquid natural gas tanker trailer in order to minimize or eliminate venting, which would be undertaken in order to reduce pressure from the tanker.

A vehicle natural gas fuel supply system is disclosed herein, in a preferred embodiment, comprising: a vehicle-tank natural gas fuel supply assembly and a vehicle natural gas fuel supply assembly, and at least one quick-connect-coupler for removably coupling the vehicle-tank natural gas fuel supply assembly and the vehicle natural gas fuel supply assembly such that the vehicle-tank natural gas fuel supply assembly and the vehicle natural gas fuel supply are in fluid communication when coupled, and independently isolated when uncoupled. The vehicle natural gas fuel supply system may comprise the vehicle-tank natural gas fuel supply assembly coupled to the vehicle natural gas fuel supply assembly via the at least one quick-connect-coupler, in functional combination. The vehicle-tank comprises a liquefied natural gas tanker-trailer and the vehicle-tank comprises a pressurized vessel, in preferred embodiments.

In a preferred embodiment, the vehicle-tank natural gas fuel supply assembly may comprise a vehicle-tank, a tank-pressure-transmitter, a tank-shut-off valve, and a tank-break-away-coupler, and a dedicated-pressure-build-up line in functional combination. The dedicated-pressure-build-up line may comprise a pressure-build-up-circuit, a pressure-build-up-circuit-shut-off-valve, and a pressure-build-up-line-hose in functional combination.

Further, a preferred embodiment of the vehicle natural gas fuel supply assembly may comprise a vehicle-hose, a pressure-indicator, a vehicle-shut-off-valve, a vehicle-pressure-transmitter, a vehicle-fuel-heater, a vehicle-surge-chamber-connection, a vehicle-low-pressure-shut-off-valve, and a vehicle-low-pressure regulator in functional combination.

The preferred embodiment of the vehicle natural gas fuel supply system is structured and arranged to controllably transport natural gas from the vehicle-tank to an engine for a prime mover such that captured natural gas is able to be burned in the engine to provide motion for the prime mover; wherein the captured natural gas is removed from a vapor space of the vehicle-tank and the captured natural gas may be provided via a pressure build procedure to increases a vapor pressure which induces a fuel transfer from the vehicle-tank. The pressure build procedure induces a fuel transfer from the vehicle-tank to the engine and the pressure build procedure is able to be controlled manually to build pressure.

In a preferred embodiment, the vehicle natural gas fuel supply system is structured and arranged to minimize the need to vent the captured natural gas from the vehicle-tank and the captured natural gas, by remaining in a closed system and not being vented, effectively preventing unburned methane from entering into an ambient environment. The captured natural gas is directed through an air-gas mixer before reaching the engine of the prime-mover for motive action. In the preferred embodiment, the engine comprises an engine which is able to use natural gas as a fuel, either in full or in part, and the engine uses the captured natural gas such that fuel is available regardless if the tank being pulled is empty or full.

The vehicle-fuel-heater raises and lowers a relative temperature of the captured natural gas such that the captured natural gas is appropriately heated for burning in the engine. The vehicle-tank is pulled by the prime mover and vehicle-tank is not an on-board fuel supply tank of the prime mover in a preferred embodiment, rather the tank is embodied by the tanker.

The regulator regulates pressure to the appropriate pressure required for the supply of fuel to the engine. In the case of a compressed natural gas trailer, the gas may be regulated in pressure at the trailer.

A kit is also described for manufacture, sale and use. The kit includes, at least, the vehicle-tank natural gas fuel supply assembly, the vehicle natural gas fuel supply assembly, the at least one quick-connect-coupler, and a set of user installation and use/maintenance instructions.

A method of using a vehicle natural gas fuel supply system is also described herein for use with the present invention. The method comprises the steps of providing a vehicle-tank natural gas fuel supply assembly, a vehicle natural gas fuel supply assembly, and at least one quick-connect-coupler, coupling the vehicle-tank natural gas fuel supply assembly and the vehicle natural gas fuel supply assembly via the at least one quick-connect-coupler, and operating an engine for a prime mover such that captured natural gas is able to be burned in the engine to provide motion for the prime mover as an alternate to diesel fuel. The method of using a vehicle natural gas fuel supply system may further include the steps of ceasing operation of the prime mover and decoupling the vehicle-tank natural gas fuel supply assembly and the vehicle natural gas fuel supply assembly via the at least one quick-connect-coupler.

The present invention holds significant improvements and serves as a vehicle natural gas fuel supply system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, vehicle natural gas fuel supply system, constructed and operative according to the teachings of the present invention.

FIG. 1 shows a perspective view illustrating a vehicle natural gas fuel supply system during an ‘in-use’ condition showing a liquefied natural gas tanker-trailer pulled prime mover according to an embodiment of the present invention.

FIG. 2 is a schematic diagram of a vehicle natural gas fuel supply system according to an embodiment of the present invention of FIG. 1.

FIG. 3 is a schematic diagram illustrating a vehicle-tank natural gas fuel supply assembly of the vehicle natural gas fuel supply system of FIGS. 1 and 2 according to an embodiment of the present invention.

FIG. 4 is a schematic diagram illustrating the vehicle natural gas fuel supply assembly of the vehicle natural gas fuel supply system of FIGS. 1 and 2 according to an embodiment of the present invention.

FIG. 5 is a flowchart illustrating a method of use for the vehicle natural gas fuel supply system according to an embodiment of the present invention of FIGS. 1-4.

The various embodiments of the present invention will hereinafter be described in conjunction with the appended drawings, wherein like designations denote like elements.

### DETAILED DESCRIPTION

As discussed above, embodiments of the present invention relate to a vehicle fuel systems and more particularly to a vehicle natural gas fuel supply system as used to improve the operational range of a liquefied natural gas tanker trailer or compressed natural gas trailer, reduce waste of natural gas during transport and reduce the need to vent excess natural gas to the ambient environment thereby minimizing negative environmental impact.

Generally speaking, a vehicle natural gas fuel supply system allows a tractor pulling a liquefied natural gas tanker trailer, a compressed natural gas trailer, or cargo-mounted tanks, to be fueled by natural gas vapor directly from the tanker trailer without the need for on-board natural gas storage tanks. By using natural gas vapor, or compressed natural gas, from the tanker trailer or cargo-mounted tanks, the potential to discharge excess natural gas into the ambient environment is reduced. Additionally, by using the natural gas vapor from the tanker trailer or cargo-mounted tanks, the overall range of the tractor is increased and allows natural gas deliveries to remote locations that would not have the ability to be served by a standard natural gas powered vehicle.

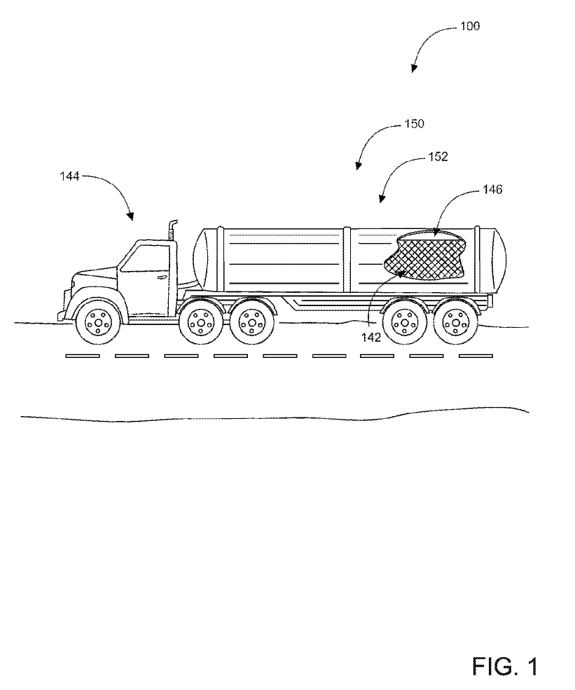

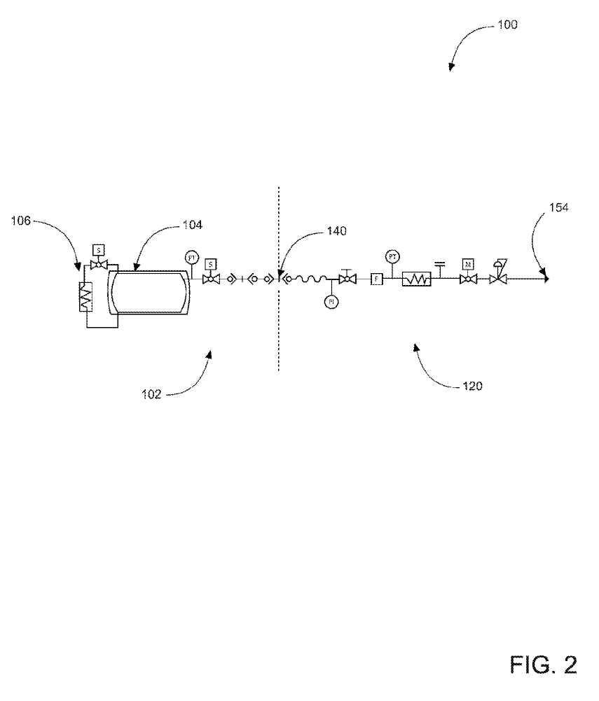

Referring to the drawings by numerals of reference there is shown in FIGS. 1-4 various views of vehicle natural gas fuel supply system 100 comprising: vehicle-tank natural gas fuel supply assembly 102, vehicle natural gas fuel supply assembly 120, and at least one quick-connect-coupler 140 for removable coupling of vehicle-tank natural gas fuel supply assembly 102 and vehicle natural gas fuel supply assembly 120 such that vehicle-tank natural gas fuel supply assembly 102 and vehicle natural gas fuel supply assembly 120 are in fluid communication when coupled and independently isolated when uncoupled. Vehicle natural gas fuel supply system 100 comprises vehicle-tank natural gas fuel supply assembly 102 and vehicle natural gas fuel supply assembly 120 in functional combination.

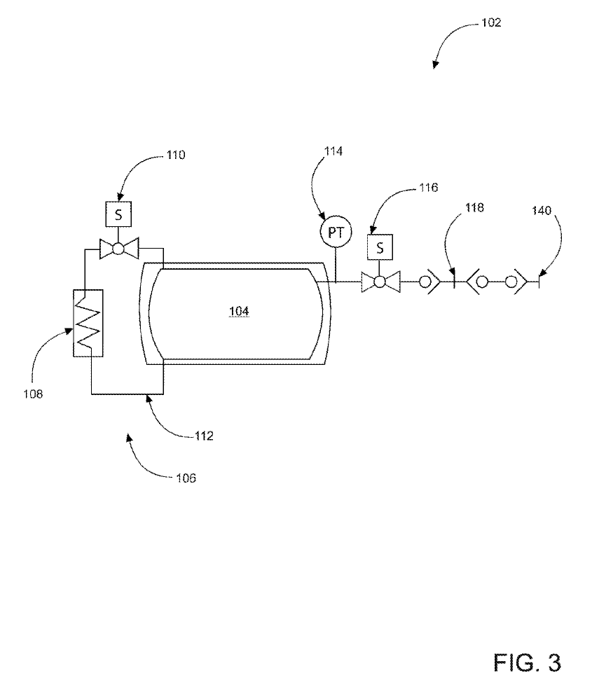

Referring now more specifically to FIG. 3, vehicle-tank natural gas fuel supply assembly 102 comprises vehicle-tank 104, tank-pressure-transmitter 114, tank-shut-off valve 116, tank-break-away-coupler 118, and dedicated-pressure-build-up line 106. Dedicated-pressure-build-up line 106 comprises pressure-build-up-circuit 108, pressure-build-up-circuit-shut-off-valve 110, and pressure-build-up-line-hose 112 in functional combination. Vehicle-tank 140 is pulled by prime mover 144 and vehicle-tank 104 is not an on-board fuel supply tank of prime mover 144. Vehicle-tank 104 may comprise a liquefied natural gas tanker-trailer 150, and additionally, vehicle-tank 104 may comprise a pressurized vessel 152.

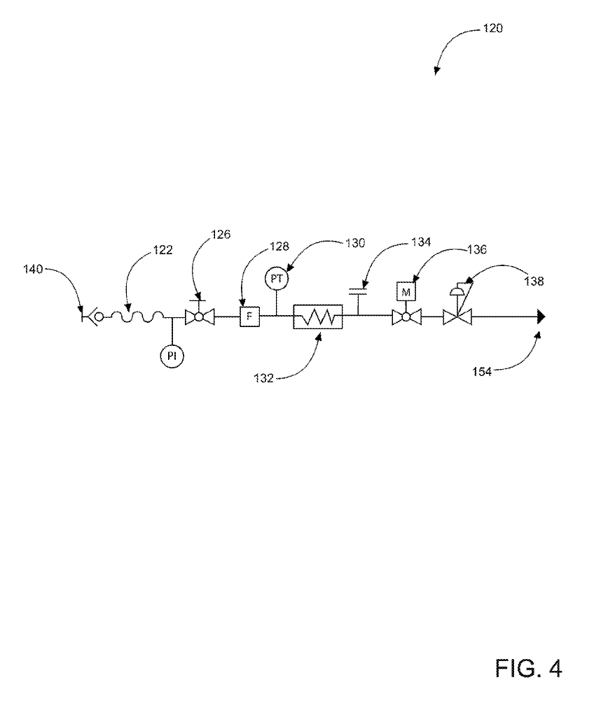

Now referring to FIG. 4, vehicle natural gas fuel supply assembly 102 comprises vehicle-hose 122, pressure-indicator 124, vehicle-shut-off-valve 126, vehicle-filter 128, vehicle-pressure-transmitter 130, vehicle-fuel-heater 132, vehicle-surge-chamber-connection 134, vehicle-low-pressure-shut-off-valve 136, and vehicle-low-pressure regulator 138 in functional combination. Vehicle-fuel-heater 132 raises and lowers a relative temperature of captured natural gas such that captured natural gas is appropriately heated for burning in engine 148. In some embodiments, engine 148, may comprises a dual-fuel-engine and dual fuel engine may use diesel fuel and captured natural gas, either exclusively or in combination. Those with ordinary skill in the art will now appreciate that upon reading this specification and by their understanding the art of treatment of natural gas for efficient burning in engines as described herein, methods of temperature regulation, delivery, safety in use, tank pressure management procedures and the like will be understood by those knowledgeable in such art.

Vehicle natural gas fuel supply system 100 is structured and arranged to controllably transport natural gas from vehicle-tank 104 to an engine for prime mover 144 such that captured natural gas is able to be burned in engine 144 to provide motion for prime mover 144.

Captured natural gas is provided via a pressure building procedure from vehicle-tank 104 and captured natural gas is removed from vapor space 146 of vehicle-tank 104. Vapor space 146 may also include cargo space, in some embodiments. Pressure building procedure, if required, increases a vapor pressure which induces a fuel transfer from vehicle-tank 104 to engine 144. In an embodiment, vapor pressure is able to be controlled manually to build pressure (when required for liquefied natural gas tanks); and in an alternate embodiment, vapor pressure is able to be controlled non-manually to build pressure. Captured natural gas may be directed through an air-gas mixer 154 before reaching engine 148.

Vehicle natural gas fuel supply system 100 is structured and arranged to eliminate a need to vent captured natural gas from vehicle-tank 104 and captured natural gas, by remaining in a closed system and not being vented, effectively preventing unburned methane from entering into an ambient environment.

Vehicle natural gas fuel supply system 100 may be sold as a kit comprising the following parts: at least one vehicle-tank natural gas fuel supply assembly 102; at least one quick-connect-coupler 140; and at least one set of user instructions. The kit has instructions such that functional relationships are detailed in relation to the structure of the invention (such that the invention can be used, maintained, or the like in a preferred manner). Vehicle natural gas fuel supply system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

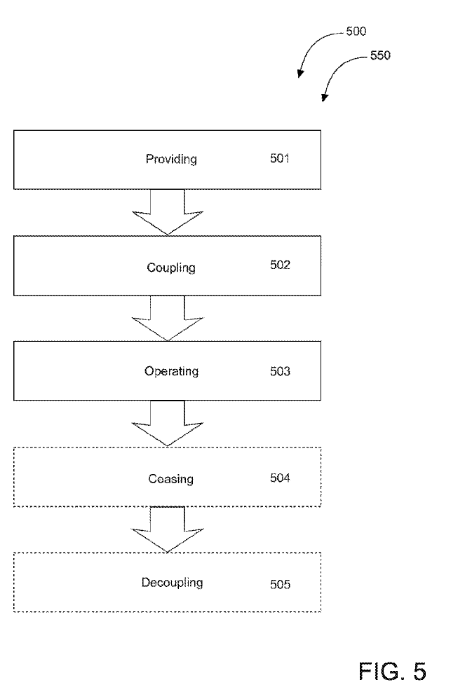

Referring now to FIG. 5 showing flowchart 550 illustrating method of use 500 for vehicle natural gas fuel supply system 100 according to an embodiment of the present invention of FIGS. 1-4.

As shown, method of use 500 may comprise the steps of: step one 501, providing a vehicle-tank natural gas fuel supply assembly 102, a vehicle natural gas fuel supply assembly 120, and at least one quick-connect-coupler 140; step two 502, coupling vehicle-tank natural gas fuel supply assembly 102 and vehicle natural gas fuel supply assembly 120 via at least one quick-connect-coupler 140; and step three 503, operating an engine 148 for a prime mover 144 such that captured natural gas is able to be burned in engine 148 to provide motion for prime mover 144 as an alternate fuel source to diesel fuel. Method of use 500 may further comprise the steps of: step four 504, ceasing operation of prime mover 144; and step five 505, decoupling vehicle-tank natural gas fuel supply assembly decoupling said vehicle-tank natural gas fuel supply assembly and said vehicle natural gas fuel supply assembly via said at least one quick-connect-coupler 102 and vehicle natural gas fuel supply assembly 120 via at least one quick-connect-coupler 140.

It should be noted that steps four 504 and five 505 are optional steps and may not be implemented in all cases. Optional steps of method of use 500 are illustrated using dotted lines in FIG. 5 so as to distinguish them from the other steps of method of use 500.

It should be noted that the steps described in the method of use can be carried out in many different orders according to user preference. The use of “step of” should not be interpreted as “step for”, in the claims herein and is not intended to invoke the provisions of 35 U.S.C. §112, ¶6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A vehicle natural gas fuel supply system comprising:
a vehicle-tank natural gas fuel supply assembly comprising;
a vehicle-tank;
a dedicated-pressure-build-up line comprising;
a pressure-build-up-circuit;
a pressure-build-up-circuit-shut-off-valve; and
a pressure-build-up-line-hose;
a tank-pressure-transmitter;
a tank-shut-off valve;
a tank-break-away-coupler;
a vehicle natural gas fuel supply assembly comprising;
a vehicle-hose;
a pressure-indicator;
a vehicle-shut-off-valve;
a vehicle-filter;
a vehicle-pressure-transmitter;
a vehicle-fuel-heater;
a vehicle-surge-chamber-connection;
a vehicle-low-pressure-shut-off-valve; and
a vehicle-low-pressure regulator;
at least one quick-connect-coupler for removable coupling of said vehicle-tank natural gas fuel supply assembly and said vehicle natural gas fuel supply assembly such that said vehicle-tank natural gas fuel supply assembly and said vehicle natural gas fuel supply assembly are in fluid communication when coupled and independently isolated when uncoupled;
wherein said vehicle natural gas fuel supply system comprises said vehicle-tank natural gas fuel supply assembly and said vehicle natural gas fuel supply assembly in functional combination;
wherein said vehicle-tank natural gas fuel supply assembly comprises said vehicle-tank said dedicated-pressure-build-up line, said tank-pressure-transmitter, said tank-shut-off valve, and said tank-break-away-coupler in functional combination;
wherein said dedicated-pressure-build-up line comprises said pressure-build-up-circuit, said pressure-build-up-circuit -shut-off-valve, and said pressure-build-up-line-hose in functional combination;
wherein said vehicle natural gas fuel supply assembly comprise said vehicle-hose, said pressure-indicator, said vehicle-shut-off-valve, and said vehicle-filter, said vehicle-pressure-transmitter said vehicle-fuel-heater, said vehicle-surge-chamber-connection, said vehicle-low-pressure-shut-off-valve, and said vehicle-low-pressure regulator in functional combination; and
wherein said vehicle natural gas fuel supply system is structured and arranged to controllably transport natural gas from said vehicle-tank to an engine for a prime mover such that captured natural gas is able to be burned in said engine to provide motion for said prime mover.

2. The vehicle natural gas fuel supply system of claim 1 wherein said captured natural gas is removed from a vapor space of said vehicle-tank.

3. The vehicle natural gas fuel supply system of claim 2 wherein said captured natural gas is provided via a pressure build procedure from said vehicle-tank.

4. The vehicle natural gas fuel supply system of claim 3 wherein said vehicle-fuel-heater raises and lowers a relative temperature of said captured natural gas such that said captured natural gas is appropriately heated for burning in said engine.

5. The vehicle natural gas fuel supply system of claim 4 wherein said vehicle-tank is pulled by said prime mover.

6. The vehicle natural gas fuel supply system of claim 5 wherein said vehicle-tank is not an on-board fuel supply tank of said prime mover.

7. The vehicle natural gas fuel supply system of claim 3 wherein said pressure build procedure increases a vapor pressure which induces a fuel transfer from said vehicle-tank to said engine.

8. The vehicle natural gas fuel supply system of claim 7 wherein said vapor pressure is able to be controlled manually to build pressure.

9. The vehicle natural gas fuel supply system of claim 7 wherein said vapor pressure is able to be controlled non-manually to build pressure.

10. The vehicle natural gas fuel supply system of claim 1 wherein said engine comprises a dual-fuel-engine.

11. The vehicle natural gas fuel supply system of claim 1 wherein said vehicle natural gas fuel supply system is structured and arranged to minimize a need to vent said captured natural gas from said vehicle-tank.

12. The vehicle natural gas fuel supply system of claim 11 wherein said captured natural gas, by remaining in a closed system and not being vented, effectively prevents unburned methane from entering into an ambient environment.

13. The vehicle natural gas fuel supply system of claim 12 wherein said dual-fuel-engine uses diesel fuel and captured natural gas.

14. The vehicle natural gas fuel supply system of claim 12 wherein said vehicle-tank comprises a liquefied natural gas tanker-trailer.

15. The vehicle natural gas fuel supply system of claim 14 wherein said vehicle-tank comprises a pressurized vessel.

16. The vehicle natural gas fuel supply system of claim 4 wherein said captured natural gas is directed through an air-gas mixer before reaching said engine.

17. A vehicle natural gas fuel supply system comprising:
a vehicle-tank natural gas fuel supply assembly comprising;
a vehicle-tank;
a dedicated-pressure-build-up line comprising;
a pressure-build-up-circuit;
a pressure-build-up-circuit-shut-off-valve; and
a pressure-build-up-line-hose;
a tank-pressure-transmitter;
a tank-shut-off valve;
a tank-break-away-coupler;
a vehicle natural gas fuel supply assembly comprising;
a vehicle-hose;
a pressure-indicator;
a vehicle-shut-off-valve;
a vehicle-filter;
a vehicle-pressure-transmitter;
a vehicle-fuel-heater;
a vehicle-surge-chamber-connection;
a vehicle-low-pressure-shut-off-valve; and
a vehicle-low-pressure regulator;
at least one quick-connect-coupler for removable coupling of said vehicle-tank natural gas fuel supply assembly and said vehicle natural gas fuel supply assembly such that said vehicle-tank natural gas fuel supply assembly and said vehicle natural gas fuel supply are in fluid communication when coupled and independently isolated when uncoupled;
wherein said vehicle natural gas fuel supply system comprises said vehicle-tank natural gas fuel supply assembly and said vehicle natural gas fuel supply assembly in functional combination;
wherein said vehicle-tank natural gas fuel supply assembly comprises said vehicle-tank said dedicated-pressure-build-up line, said tank-pressure-transmitter, said tank-shut-off valve, and said tank-break-away-coupler in functional combination;
wherein said dedicated-pressure-build-up line comprises said pressure-build-up-circuit, said pressure-build-up-circuit-shut-off-valve, and said pressure-build-up-line-hose in functional combination;
wherein said vehicle natural gas fuel supply assembly comprise said vehicle-hose, said pressure-indicator, said vehicle-shut-off-valve, and said vehicle-filter, said vehicle-pressure-transmitter said vehicle-fuel-heater, said
vehicle-surge-chamber-connection, said vehicle-low-pressure-shut-off-valve, and said vehicle-low-pressure regulator in functional combination;
wherein said vehicle natural gas fuel supply system is structured and arranged to controllably transport natural gas from said vehicle-tank to an engine for a prime mover such that captured natural gas is able to be burned in said engine to provide motion for said prime mover;
wherein said captured natural gas is removed from a vapor space of said vehicle-tank;
wherein said captured natural gas is provided via a pressure build procedure increases a vapor pressure which induces a fuel transfer from said vehicle-tank;
wherein said vehicle-fuel-heater raises and lowers a relative temperature of said captured natural gas such that said captured natural gas is appropriately heated for burning in said engine;
wherein said vehicle-tank is pulled by said prime mover;
wherein said vehicle-tank is not an on-board fuel supply tank of said prime mover;
wherein said pressure build procedure induces a fuel transfer from said vehicle-tank to said engine;
wherein said pressure build procedure is able to be controlled manually to build pressure;
wherein said engine comprises a dual-fuel-engine;
wherein said dual-fuel-engine uses diesel fuel and captured natural gas;
wherein said vehicle natural gas fuel supply system is structured and arranged to minimize a need to vent said captured natural gas from said vehicle-tank;
wherein said captured natural gas, by remaining in a closed system and not being vented, effectively prevents unburned methane from entering into an ambient environment;
wherein said vehicle-tank comprises a liquefied natural gas tanker-trailer;
wherein said vehicle-tank comprises a pressurized vessel; and
wherein said captured natural gas is directed through an air-gas mixer before reaching said engine of said prime-mover for motive action.

18. The vehicle natural gas fuel supply system of claim 17 further comprising a kit including:
said vehicle-tank natural gas fuel supply assembly;
said vehicle natural gas fuel supply assembly;
said at least one quick-connect-coupler; and
a set of user installation and use instructions.

19. A method of using a vehicle natural gas fuel supply system comprising the steps of:
providing a vehicle-tank natural gas fuel supply assembly, a vehicle natural gas fuel supply assembly, and a at least one quick-connect-coupler;
coupling said vehicle-tank natural gas fuel supply assembly and said vehicle natural gas fuel supply assembly via said at least one quick-connect-coupler; and
operating an engine for a prime mover such that captured natural gas is able to be burned in said engine to provide motion for said prime mover alternately to diesel fuel.

20. The method of claim 19 further comprising the steps of:
ceasing operation of said prime mover; and
decoupling said vehicle-tank natural gas fuel supply assembly and said vehicle natural gas fuel supply assembly via said at least one quick-connect-coupler.
